(19) United States
(12) Patent Application Publication
(10) Pub. No.: US 2026/0151694 A1
(43) Pub. Date: Jun. 4, 2026

(54) ULTRA-LOW-LATENCY GAME SYSTEM

(71) Applicant: AIFRUTECH CO., LTD., Shenzhen City (CN)

(72) Inventor: CHENGHAO WU, Shenzhen City (CN)

(73) Assignee: AIFRUTECH CO., LTD., Shenzhen City (CN)

(21) Appl. No.: 19/458,912

(22) Filed: Jan. 25, 2026

Related U.S. Application Data
(63) Continuation of application No. PCT/CN2024/083000, filed on Mar. 21, 2024.

(30) Foreign Application Priority Data
Jul. 26, 2023 (CN) 202310922117.4

(51) Int. Cl. A63F 13/235; H04W 4/80

(52) U.S. Cl. CPC A63F 13/235; H04W 4/80

(57) ABSTRACT

An ultra-low-latency game system includes a game console and at least one game control device, each of the game control devices being communicatively connected to the game console. The game console includes a first ultra-low-latency communication module, and the game control device includes a second ultra-low-latency communication module. The game console achieves an ultra-low-latency communication connection with the game control device through the first ultra-low-latency communication module and the second ultra-low-latency communication module. The present application realizes ultra-low-latency communication between the game console and the game control device, significantly reducing the communication delay between the game control device and the game console to between 0.2 ms and 8.2 ms. Compared to the existing delay of 16 ms, this greatly shortens the latency, substantially improves transmission efficiency, and significantly enhances the gaming operation experience.

### CROSS-REFERENCE TO RELATED APPLICATIONS

The present application is a continuation of International Patent Application No. PCT/CN2024/083000 filed on Mar. 21, 2024, which claims the priority of China patent Application No. 202310922117.4 filed on Jul. 26, 2023, the entire contents of which are incorporated herein by reference.

### TECHNICAL FIELD

The present application relates to the field of game system technology, and in particular to an ultra-low-latency game system.

### BACKGROUND

With the development of technology, smart terminals such as computers, smartphones, and game control devices have gained widespread popularity and have led to increasingly rich functionalities. The game industry has subsequently experienced rapid growth, with a growing variety of game types, particularly control-based games, which are highly favored by users. This has led to an influx of game systems into the market. Gamers are also demanding higher performance for game control devices, smart terminals, and associated electronic devices.

Existing game control devices typically use USB or Bluetooth for signal transmission. Bluetooth communication often has a latency exceeding 100 ms, and Bluetooth signals can suffer from mutual interference, leading to data loss and significant transmission delays. USB communication latency is generally above 8 ms, typically ranging from 8 ms to 16 ms. A round-trip time between the game console and the game control device might reach 16 ms, meaning the game console can only process information every 16 ms, resulting in relatively long latency. Therefore, existing wired or wireless game control devices have issues such as long communication time with the game console and data transmission delay, which may affect the user's gaming experience. Therefore, there is an urgent need for a game system capable of achieving ultra-low-latency.

### SUMMARY

Accordingly, the present application is directed to an ultra-low-latency game system to address technical issues in existing game systems, such as excessively long latency and poor user experience.

An ultra-low-latency game system is provided which includes a game console and at least one game control device, each of the at least one game control device being configured to be communicatively connected to the game console. The game console comprises a first ultra-low-latency communication module, each of the at least one game control device comprises a second ultra-low-latency communication module, and the game console is configured to achieve an ultra-low-latency communication connection with each of the at least one game control devices via the first ultra-low-latency communication module and the second ultra-low-latency communication module. A delay period of the ultra-low-latency is settable via HID descriptors of the first ultra-low-latency communication module and the second ultra-low-latency communication module, and the delay period of the ultra-low-latency does not exceed 0.2 ms to n+0.2 ms, where n is an integer in the range of 1 to 8.

In some embodiments, the first ultra-low-latency communication module comprises a first UWB module, the second ultra-low-latency communication module comprises a second UWB module, and the delay period of the ultra-low-latency for wireless communication between the first UWB module and the second UWB module does not exceed 0.2 ms to n+0.2 ms, where n is an integer in the range of 1 to 8.

In some embodiments, the game console further comprises a USB Dongle receiver, and the first ultra-low-latency communication module is disposed in the USB Dongle receiver.

In some embodiments, wherein the first ultra-low-latency communication module further comprises a first USB module, the second ultra-low-latency communication module further comprises a second USB module, a wired communication between the first USB module and the second USB module uses an interrupt transfer mode, and the delay period of the ultra-low-latency for the interrupt transfer mode does not exceed 0.2 ms to n+0.2 ms, where n is an integer in the range of 1 to 8.

In some embodiments, each of the at least one game control device further comprises a signal acquisition module and a buffer. The signal acquisition module is configured to periodically scan and acquire a button state signal of each game button of a corresponding one of the at least one game control device at each scan cycle, store the acquired button state signal in the buffer in real time, and transmit the stored button state signal to the game console via the second ultra-low-latency communication module within a transmission period; wherein the transmission period is a duration for transmitting the button state signal, and the delay period is equal to the transmission period plus a buffer period.

In some embodiments, when n is 1, the delay period is 1 ms, the scan cycle is 100 μs, the buffer period is 800 μs, and the transmission period is 200 μs.

In some embodiments, if a button state signal is acquired by one of the at least one game control device at a transmission start time point of the transmission period and is promptly stored in the buffer, it is then transmitted to the game console within the transmission period, resulting in a minimum delay time of 0.2 ms; if a button state signal is acquired by one of the at least one game control device at a buffer start time point of the buffer period and is promptly stored in the buffer, it is then transmitted to the game console in the transmission period, resulting in a delay time of 1.0 ms; if a button state signal was acquired by one of the at least one game control device during the transmission period of a previous delay period and was not promptly stored in the buffer, it is then transmitted to the game console during the transmission period of a current delay period, resulting in a maximum delay time of 1.2 ms. The transmission start time point is at 0 μs, at which the transmission period starts.

In some embodiments, each of the at least one game control device further comprises a button control positioning module and a switching module. The second UWB module is further configured to perform relative positioning of a corresponding one of the at least one game control device. The button control positioning module is configured to perform absolute positioning of a corresponding one of the at least one game control device. The switching module is configured to switch a positioning mode of a corresponding one of the at least one game control device between the second UWB module and the button control positioning module based on a game type of a game executed on the game console, thereby determining the positioning mode of the corresponding one of the at least one game control device as a UWB positioning mode or a traditional positioning mode. When the positioning mode of the corresponding one of the at least one game control device is the UWB positioning mode, the game console is configured to wirelessly communicate with the second UWB module of the corresponding one of the at least one game control device via the first UWB module, and the second UWB module is configured to determine a distance between the corresponding one of the at least one game control device and the game console, wherein the at least one game control device comprises multiple game control devices that wirelessly communicate with each other via the second UWB modules to determine mutual distances between the game control devices.

In some embodiments, when each of the game control devices determines that its positioning mode is the UWB positioning mode, it is configured to, at each delay period: transmit a positioning data signal to the second UWB modules of the other game control devices via its own second UWB module and record a transmission time; wait for feedback signals from the other game control devices and record a reception time; calculate real-time relative position information between itself and each of the other game control devices based on a time difference between the reception time and the transmission time as well as a data transmission rate; and each of the game control devices scans and acquires its corresponding button state signal and real-time relative position information, and promptly transmits them to the game console. When each of the game control devices determines that its positioning mode is the traditional positioning mode, it is configured to, at each delay period, obtain its own real-time absolute position information via the button control positioning module; and each of the game control devices scans and acquires its corresponding button state signal and real-time absolute position information, and promptly transmits them to the game console.

In some embodiments, each of the game control devices further comprises a device control module and a game button, and the device control module is connected to each of the second ultra-low-latency communication module, the signal acquisition module, the buffer, the button control positioning module, the switching module, and the game button. The game console is configured to receive the real-time relative position information of each of the game control devices and, based on the received real-time relative position information, match in real time a relevant spatial position for a game character corresponding to each of the game control devices; and the game console is configured to receive the button state signal of each of the game control devices and, based on the received button state signal, match in real time a relevant game action for the game character corresponding to each of the game control devices.

Implementation of one of the technical solutions of the present application described above provides the following advantages or beneficial effects: the present application achieves an ultra-low-latency communication connection between the game console and the game control device. The communication delay from the game control device to the game console is significantly reduced to within 0.2 ms to 8.2 ms. Compared to the 16 ms delay in existing systems, the present application greatly shortens the latency, substantially improves transmission efficiency, and significantly enhances the game operation experience.

### BRIEF DESCRIPTION OF THE DRAWINGS

To provide a clearer explanation of the technical solutions in the embodiments of the present application, accompanying drawings to be used in the description of the embodiments will be briefly introduced below. Obviously, the accompanying drawings in the following description illustrate only some embodiments of the present application. For those of ordinary skill in the art, other drawings can also be obtained based on these drawings without creative efforts.

FIG. 1 is a schematic diagram of an overall structure of an ultra-low-latency game system according to one embodiment.

FIG. 2 is a flowchart of an ultra-low-latency communication process of the ultra-low-latency game system according to one embodiment.

FIG. 3 is a schematic diagram of a structure of a game control device of the ultra-low-latency game system according to one embodiment.

FIG. 4 is a first schematic diagram of a structure of a game console in the ultra-low-latency game system according to one embodiment.

FIG. 5 is a second schematic diagram of a structure of a game console in the ultra-low-latency game system according to one embodiment.

FIG. 6 is a flowchart of ultra-low-latency game operation steps of the ultra-low-latency game system according to one embodiment.

Reference numerals in the Figures: 1: Game console; 11: First ultra-low-latency communication module; 111: First UWB module; 112: First USB module; 12: USB Dongle receiver; 13: Console control module; 2: Game control device; 21: Second ultra-low-latency communication module; 211: Second UWB module; 212: Second USB module; 23: Buffer; 24: Button control positioning module; 25: Switching module; 26: Device control module; 27: Game button; 28: Power module.

### DESCRIPTION OF THE EMBODIMENTS

To make the objectives, technical solutions, and advantages of the present application clearer, various exemplary embodiments are described below with reference to the corresponding drawings. These drawings form a part of the exemplary embodiments and illustrate various exemplary embodiments that may be adopted to implement the application. Unless otherwise indicated, the same numbers in different drawings denote the same or similar elements. The implementations described in the following exemplary embodiments do not represent all implementations of the present disclosure. Rather, they are merely examples of processes, methods, devices, etc., consistent with some aspects of the present application as stated in the appended claims. Other embodiments may be used, or structural and functional modifications may be made to the embodiments described herein, without departing from the scope and spirit of the application.

In the description of the present application, terms such as “center,” “longitudinal,” “transverse,” etc., indicate orientations or positional relationships based on those shown in the drawings. They are used only for convenience in describing the application and simplifying the description, rather than indicating or implying that the referred device or element must have a specific orientation or be constructed and operated in a specific orientation. Terms such as “first,” “second,” etc., are used for descriptive purposes only and are not to be construed as indicating relative importance or implicitly specifying the quantity of the indicated technical features. The term “a plurality of” means two or more. Terms like “connected,” “coupled,” etc., should be interpreted broadly; for example, a connection may be a fixed connection, a detachable connection, an integral connection, a mechanical connection, an electrical connection, a communication connection, a direct connection, an indirect connection via an intermediate component, a wired connection, or a wireless connection. It may refer to the internal communication between two elements or the interaction between two elements. The term “and/or” includes any and all combinations of one or more of the associated listed items. Those of ordinary skill in the art can understand the specific meanings of these terms in the present application based on the specific context.

The technical solutions of the present application are explained in conjunction with specific embodiments, in which only parts related to the embodiments of the present application are shown.

### Embodiment 1

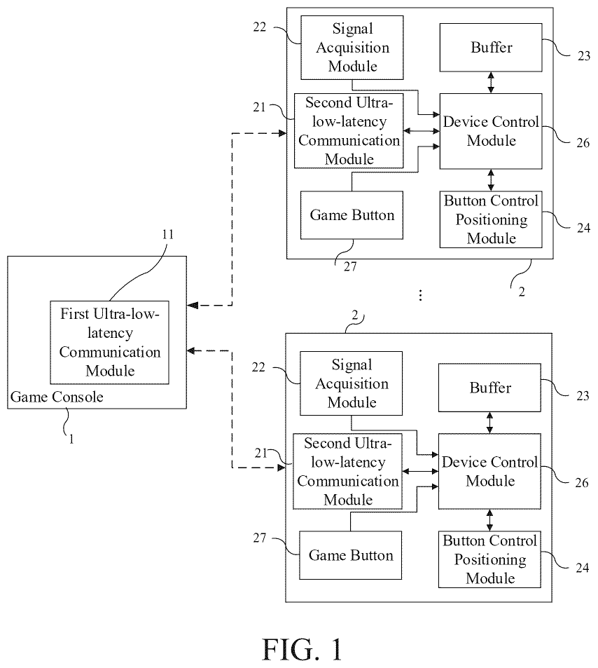

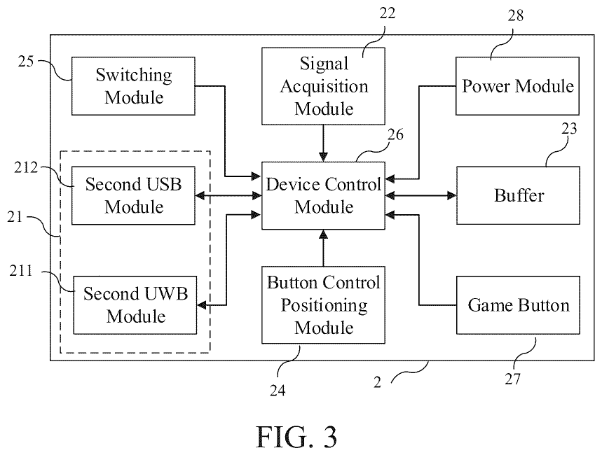

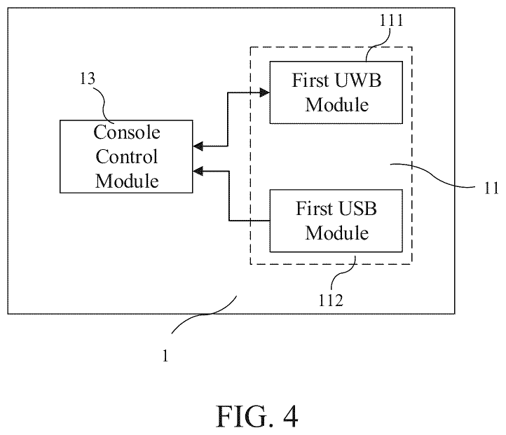

As shown in FIG. 1 through FIG. 4, an ultra-low-latency game system in accordance with one embodiment of the present application includes a game console 1 and at least one game control device 2. Each game control device 2 is communicatively connected to the game console 1 (in a wired or wireless manner). Specifically, the game console 1 includes a first ultra-low-latency communication module 11, and the game control device 2 includes a second ultra-low-latency communication module 21. The game console 1 achieves an ultra-low-latency communication connection with each game control device 2 through the first ultra-low-latency communication module 11 and the second ultra-low-latency communication module 21. A delay period of the ultra-low-latency is settable via HID (human interface device) descriptors of the first ultra-low-latency communication module 11 and the second ultra-low-latency communication module 21. The ultra-low-latency delay period does not exceed 0.2 ms to n+0.2 ms, where n is an integer in the range of 1 to 8.

As an optional implementation, the first ultra-low-latency communication module 11 may be built-in (i.e., directly installed inside the game console 1). Alternatively, the first ultra-low-latency communication module 11 may be an external component. That is, for example, the game console 1 may further include a USB Dongle receiver 12, and the first ultra-low-latency communication module 11 is disposed in the USB Dongle receiver 12. This can enhance the universal compatibility of the present application, allowing it to be adapted to any game console 1, thereby significantly improving the gaming experience of existing game consoles.

As an optional implementation, the first ultra-low-latency communication module 11 may include a first UWB (ultra-wideband) module 111 and/or a first USB module 112 (i.e., it may be solely a UWB module, solely a USB module, or include both UWB and USB modules). Correspondingly, the second ultra-low-latency communication module 21 may include a second UWB module 211 and/or a second USB module 212. This means the game console 1 can establish an ultra-low-latency wireless communication connection with the game control device 2 via UWB technology, or an ultra-low-latency wired communication connection via USB technology.

As an optional implementation, the first ultra-low-latency communication module 11 includes the first UWB module 111, and correspondingly, the second ultra-low-latency communication module 21 includes the second UWB module 211. The ultra-low-latency delay period for wireless communication between the first UWB module 111 and the second UWB module 211 does not exceed 0.2 ms to n+0.2 ms, where n is an integer in the range of 1 to 8. That is, the game console 1 and the game control device 2 achieve an ultra-low-latency wireless communication connection with a delay of 0.2 ms to n+0.2 ms through UWB technology, greatly enhancing the game experience.

As an optional implementation, the first ultra-low-latency communication module 11 includes the first USB module 112, and correspondingly, the second ultra-low-latency communication module 21 includes the second USB module 212. The wired communication between the first USB module 112 and the second USB module 212 uses an interrupt transfer mode (which is a polled transfer mode). The ultra-low-latency delay period of the interrupt transfer mode does not exceed 0.2 ms to n+0.2 ms, where n is an integer in the range of 1 to 8. That is, the game console 1 and the game control device 2 achieve an ultra-low-latency wired communication connection with a delay of 0.2 ms to n+0.2 ms through USB technology, greatly enhancing the game experience.

It should be noted that both the first UWB module 111 and the second UWB module 211 use a wireless carrier communication technology with a frequency bandwidth above 1 GHz, which utilizes nanosecond-level non-sinusoidal narrow pulses to transmit data, offering advantages such as insensitivity to channel fading, low transmit signal power spectral density, low probability of intercept, low system complexity, and the ability to provide centimeter-level positioning accuracy. This can increase the signal transmission rate between devices and significantly reduce latency.

As an optional implementation, the game control device 2 further includes a signal acquisition module 22 and a buffer 23. The signal acquisition module 22 periodically scans and acquires a button state signal of each game button 27 of the game control device 2 at each scan cycle, stores it in the buffer 23 in real-time, and transmits it to the game console 1 via the second ultra-low-latency communication module 21 within a transmission period. Specifically, the transmission period is the duration for transmitting the button state signal, typically 200 μs (i.e., 0.2 ms; due to the limitations of hardware processing capability, it takes 200 μs to transmit the signal). The delay period is equal to the transmission period plus a buffer period. Specifically, the delay period, transmission period, buffer period, and scan cycle are all settable via the HID descriptors of the first and second ultra-low-latency communication modules.

As an optional implementation, since the duration of a user's normal button press operation is greater than 0.2 ms, if the duration of a button action is less than 0.2 ms, it can be judged as chatter and ignored. After the user presses a button, the signal acquisition module 22 acquires the button state signal promptly. During the buffer period, any ongoing level signal (i.e., the button state signal) can be acquired and stored in the buffer 23 in real-time. If the button is pressed during the transmission period, the button state signal is acquired after the transmission period ends and is stored in the buffer 23 in real-time. That is, the button state signal cannot be stored in the buffer 23 during the transmission period; only after the button state signal already in the buffer 23 has been transmitted to the game console 1, can the button state signal generated during the transmission period be stored into the buffer 23.

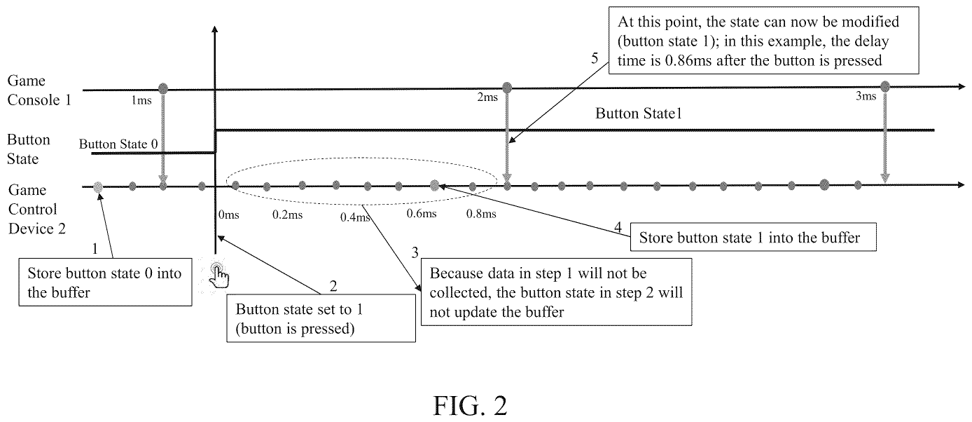

As shown in FIG. 2, in the illustrated embodiment, when n is 1, the delay period is set to 1 ms, the scan cycle is 100 μs, the buffer period is 800 μs, and the transmission period is 200 μs; consequently, the ultra-low-latency delay time does not exceed 0.2 ms to 1.2 ms, meaning the maximum delay is 1.2 ms and the minimum delay is 0.2 ms. For more accurate description, the following concepts are defined: the buffer start time point is at 0 μs, at which the buffer period starts; the buffer end time point is at 800 μs after the buffer period starts, which is also equivalent to a transmission start time point; the transmission start time point is at 0 μs, at which the transmission period starts; and the transmission end time point is at 200 μs after the transmission period starts. As another example, when n is 8, the delay period is set to 8 ms, the scan cycle is 100 μs, the buffer period is 7800 μs (i.e., 7.8 ms), and the transmission period is 200 μs; consequently, the ultra-low-latency delay time does not exceed 0.2 ms to 8.2 ms, meaning the maximum delay is 8.2 ms and the minimum delay is 0.2 ms.

As shown in FIG. 2, the HID descriptors of the first and second ultra-low-latency communication modules are used to set the ultra-low-latency delay period to 1 ms. The signal acquisition module 22 of the game control device 2 periodically (e.g. with a scan cycle of 100 μs) scans and acquires the button state signal of each game button 27 of the game control device 2, and stores the acquired button state signal in the buffer 23 in real-time. The stored button state signal is then transmitted to the game console 1 via the first ultra-low-latency communication module 11 during the transmission period. However, during the transmission period (i.e., between the transmission start time point and the transmission end time point), the button state signal cannot be stored into the buffer 23; only after the button state signal already stored in the buffer 23 has been transmitted to the game console 1, can the button state signal generated during the transmission period be stored in the buffer 23.

More specifically, if a button state signal is acquired by the game control device 2 at the transmission start time point of the transmission period and promptly stored in the buffer 23, it will be transmitted to the game console 1 within the transmission period, resulting in a minimum delay time of 0.2 ms. If a button state signal is acquired by the game control device 2 at the buffer start time point of the buffer period and promptly stored in the buffer 23, it will be transmitted to the game console 1 in the transmission period, resulting in a delay time of 1.0 ms. If a button state signal was acquired by the game control device 2 during the transmission period of a previous delay period, which could not be stored in the buffer 23 promptly during the previous delay period, it will then be transmitted to the game console 1 during the transmission period of the current delay period, resulting in a maximum delay time of 1.2 ms.

The present application achieves an ultra-low-latency communication connection between the game console and the game control device, reducing the delay of the communication between the game control device and the game console to within 0.2 ms to 1.2 ms. Compared to the 16 ms delay of existing systems, this significantly shortens the latency, greatly improves transmission efficiency, and therefore greatly enhances the game operation experience.

### Embodiment 2

As shown in FIG. 1 through FIG. 4, on the basis of Embodiment 1, the game control device 2 further includes a button control positioning module 24 and a switching module 25. The second UWB module 211 is further configured to provide relative positioning of the game control device 2. The button control positioning module 24 is configured to provide absolute positioning of the game control device 2. Specifically, the button control positioning module 24 can be up, down, left, right buttons, joystick, etc., of the game control device 2, for controlling the direction and position of game actions on the game console 1. The switching module 25 is configured to, based on the type of game executed on the game console 1, switch between the second UWB module 211 and the button control positioning module 24, thereby determining the positioning mode of the game control device 2 as a UWB positioning mode or a traditional positioning mode. Therefore, the switching module 25 enables switching between the second UWB module 211 and the button control positioning module 24.

Specifically, when the positioning mode of the game control device 2 is switched to the UWB positioning mode, the game console 1 wirelessly communicates with the second UWB module 211 of each game control device 2 via the first UWB module 111, and each second UWB module 211 determines the distance between the corresponding game control device 2 and the game console 1. A plurality of the game control devices 2 wirelessly communicates with each other through the second UWB modules 211 to determine the mutual distance between the game control devices 2.

As an optional implementation, when each game control device 2 determines that its own positioning mode is UWB positioning mode, it transmits a positioning data signal to the second UWB module of each of the other game control devices via its own second UWB module at each delay period, and records the transmission time. Each game control device 2 then waits for feedback signals from the other game control devices 2 indicating receipt of the positioning data signal, and records the reception time. Each game control device 2 calculates real-time relative position information between itself and each of the other game control devices based on the time difference between reception time and transmission time as well as the data transmission rate. Each game control device 2 acquires its corresponding button state signal and real-time relative position information, and promptly transmits them to the game console 1.

As an optional implementation, when each game control device 2 determines that its own positioning mode is traditional positioning mode, it obtains its own real-time absolute position information via its button control positioning module 24 at each delay period. Each game control device 2 acquires its button state signal and real-time absolute position information for corresponding game operations, and promptly transmits them to the game console 1.

As an optional implementation, when the game console 1 communicates with each game control device 2, game positioning of the game control device 2 can be performed via the second UWB module 211 or the button control positioning module 24, mapping the real-time position information (real-time relative position information and/or real-time absolute position information) acquired by the game control device 2 into a game scene of a game character of the game console. Specifically, the present application can switch the positioning mode between the second UWB module 211 and the button control positioning module 24. The second UWB module 211 can calculate a real-time distance of the game control device 2 itself by calculating the difference between the communication time between the game control devices 2 and the communication time between the game control device 2 and the game console 1, and based on the relative positions between the game control devices 2. This real-time distance is transmitted to the game console 1 for processing, and the result is displayed on a game display device. For games requiring high realism, this can effectively enhance the authenticity and improve the player's experience. For games where realistic distance is not critical, the button control positioning module 24 can obtain the real-time position of each game control device 2, and transmit the real-time position to the game console 1 for processing, and the result is displayed on a game display device, making the real-time position relatively close to reality, greatly enhancing the player's experience while reducing memory consumption caused by real-time distance calculation.

As an optional implementation, the game control device 2 further includes a device control module 26 and game buttons 27. The device control module 26 is connected to each of the second ultra-low-latency communication module 21, the signal acquisition module 22, the buffer 23, the button control positioning module 24, the switching module 25, and the game buttons 27. Each game control device 2 executes ultra-low-latency game operations through its device control module 26. The game console 1 receives the real-time relative position information from each game control device 2 and, based on the real-time relative position information, matches in real time a relevant spatial position for the game character corresponding to each game control device 2. The game console 1 receives the button state signal from each game control device 2 and, based on the button state signal, matches in real time a relevant game action for the game character corresponding to each game control device 2.

As an optional implementation, each device control module acquires the current game type of the game console, and each device control module acquires the switching signal of its corresponding game control device. Based on the acquired switching signal, it switches the positioning mode of its corresponding game control device. The game console receives the real-time relative position information or real-time absolute position information from each game control device and, based on this information, matches in real time the relevant spatial position for the game character corresponding to each game control device. The game console receives the button state signal from each game control device and, based on the button state signal, matches in real time the relevant game action for the game character corresponding to each game control device.

### Embodiment 3

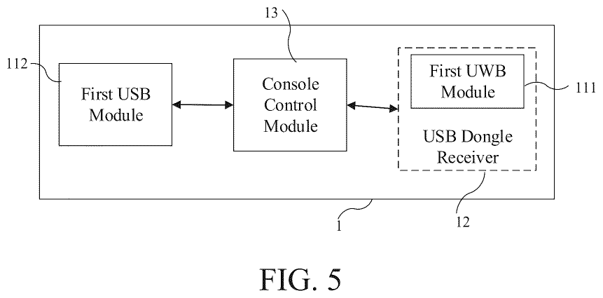

As shown in FIG. 1 through FIG. 5, the present application provides an embodiment of an ultra-low-latency game system, comprising the game console 1 and a plurality of the game control devices 2. Each game control device 2 is communicatively connected to the game console 1.

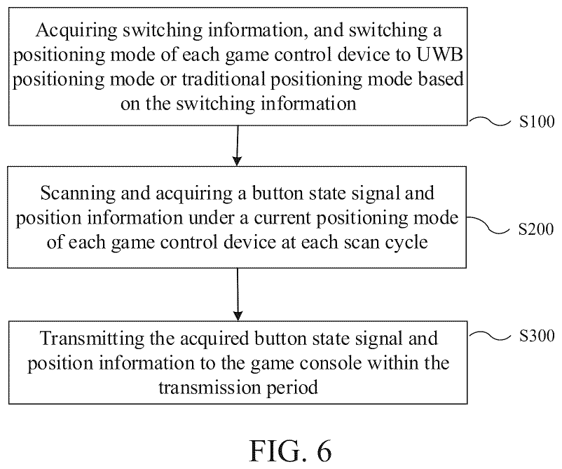

As shown in FIG. 6, ultra-low-latency game operations carried out by each game control device 2 and the game console 1 include:
S100: acquiring switching information, and switching a positioning mode of each game control device 2 to UWB positioning mode or traditional positioning mode based on the switching information;
S200: scanning and acquiring a button state signal and position information under a current positioning mode of each game control device 2 at each scan cycle;
S300: transmitting the acquired button state signal and position information to the game console 1 within the transmission period.

As an optional implementation, the game console receives the button state signals and position information from the game control devices once per delay period. It should be noted that the present application uses the device control module to achieve ultra-low-latency game data transmission, significantly reducing the delay time between the game control device and the game console to 0.2 ms to 1.2 ms. Compared to the existing 16 ms in the prior art, the delay is significantly reduced. In addition, to further avoid transmission delays caused by simultaneous data transmission from multiple game control devices and signal interference during the transmission, the present application initiates data transmission within the transmission period (200 μs), ensuring sufficient transmission duration and balanced transmission, effectively avoiding time delays during transmission.

As an optional implementation, in step S200:

When each game control device determines that its own positioning mode is UWB positioning mode, it transmits a positioning data signal to the second UWB module of each of the other game control devices via its own second UWB module at each delay period, and records the transmission time; each game control device then waits for feedback signals from the other game control devices indicating receipt of the positioning data signal, and records the reception time; each game control device calculates real-time relative position information between itself and each of the other game control devices based on the time difference between reception time and transmission time as well as the data transmission rate; each game control device acquires its corresponding button state signal and real-time relative position information, and promptly transmits them to the game console.

When each game control device determines that its own positioning mode is traditional positioning mode, it obtains its own real-time absolute position information via its button control positioning module at each delay period; each game control device acquires its button state signal and real-time absolute position information for corresponding game operations, and promptly transmits them to the game console.

As an optional implementation, by using the first UWB module 111 to wirelessly communicate with the second UWB modules 211 of multiple game control devices 2, the precise distance between each of the game control devices 2 and the game console 1 can be accurately obtained. This can realistically reproduce more detailed multi-dimensional spatial distances of the game control devices 2, making the real-time position of the game characters corresponding to the game control devices 2 more realistic, further enhancing the gaming experience.

As an optional implementation, the game control device 2 further includes a power module 28 connected to the device control module 26. Specifically, the power module 28 receives a 5V voltage, which is then stepped down to 3.3V by the power module 28. Furthermore, the second USB module 212 communicates with the device control module 26 via a DP/DM protocol, and the device control module 26 communicates with the second UWB module 211 via a UART serial port protocol.

As an optional implementation, the game console 1 further includes a console control module 13. The console control module 13 is connected to both the first ultra-low-latency communication module 11 and the USB Dongle receiver 12.

As an optional implementation, in step S100:

The device control module 26 of each game control device 2 acquires a current game type of the game console 1 and automatically switches the positioning mode of the game control device 2 corresponding to the device control module 26 based on the current game type. It should be noted that game types may include reality-based games (with an identification type that can be set to 1) and virtual games (with an identification type that can be set to 0); for example, the reality-based games include VR/3D games, and the virtual games include arcade games.

As another optional implementation, step S100 includes the following step:
Each device control module 26 acquires a switching signal of its corresponding game control device 2 and switches the positioning mode of its corresponding game control device 2 based on the acquired switching signal.

In this embodiment, the game console 1 receives the real-time relative position information or real-time absolute position information of each game control device 2 and, based on the real-time relative position information or real-time absolute position information, matches in real time the relevant spatial position for the game character corresponding to each game control device 2. The game console receives the button state signal of each game control device 2 and, based on the button state signal, matches in real time the relevant game action for the game character corresponding to each game control device 2. The spatial position and game action of each game character are displayed through a display device.

In summary, the present application uses automatic or button-controlled methods to achieve switching between multiple positioning modes of the game system, enhancing the realism of game scenes. In addition, the device control module is employed for efficient control of ultra-low-latency transmission of positioning data and button state signals, reducing the delay between the game control device and the game console to 0.2 ms to 1.2 ms. Compared to existing 16 ms in the prior art, this greatly improves transmission efficiency and provides players with a significantly improved game operation experience.

The embodiments described above are merely illustrative and do not indicate that the present application is limited to these specific implementations.

The above descriptions are merely preferred embodiments of the present application. Those skilled in the art will understand that various changes and modifications can be made to these features and embodiments without departing from the spirit and scope of the invention. In addition, under the teaching of the present application, modifications can be made to adapt to specific situations and materials without departing from the spirit and scope of the invention. Therefore, the present application is not limited by the specific embodiments disclosed herein, and all embodiments falling within the scope of the claims of this application belong to the protection scope of the present application.

What is claimed is:

1. An ultra-low-latency game system, comprising a game console and at least one game control device, each of the at least one game control device being configured to be communicatively connected to the game console; wherein the game console comprises a first ultra-low-latency communication module, each of the at least one game control device comprises a second ultra-low-latency communication module, and the game console is configured to achieve an ultra-low-latency communication connection with each of the at least one game control devices via the first ultra-low-latency communication module and the second ultra-low-latency communication module; wherein a delay period of the ultra-low-latency is settable via HID descriptors of the first ultra-low-latency communication module and the second ultra-low-latency communication module, and the delay period of the ultra-low-latency does not exceed 0.2 ms to n+0.2 ms, where n is an integer in the range of 1 to 8.

2. The ultra-low-latency game system according to claim 1, wherein the first ultra-low-latency communication module comprises a first UWB module, the second ultra-low-latency communication module comprises a second UWB module, and the delay period of the ultra-low-latency for wireless communication between the first UWB module and the second UWB module does not exceed 0.2 ms to n+0.2 ms, where n is an integer in the range of 1 to 8.

3. The ultra-low-latency game system according to claim 2, wherein the game console further comprises a USB Dongle receiver, and the first ultra-low-latency communication module is disposed in the USB Dongle receiver.

4. The ultra-low-latency game system according to claim 1, wherein the first ultra-low-latency communication module further comprises a first USB module, the second ultra-low-latency communication module further comprises a second USB module, a wired communication between the first USB module and the second USB module uses an interrupt transfer mode, and the delay period of the ultra-low-latency for the interrupt transfer mode does not exceed 0.2 ms to n+0.2 ms, where n is an integer in the range of 1 to 8.

5. The ultra-low-latency game system according to claim 2, wherein each of the at least one game control device further comprises a signal acquisition module and a buffer;
wherein the signal acquisition module is configured to periodically scan and acquire a button state signal of each game button of a corresponding one of the at least one game control device at each scan cycle, store the acquired button state signal in the buffer in real time, and transmit the stored button state signal to the game console via the second ultra-low-latency communication module within a transmission period; wherein the transmission period is a duration for transmitting the button state signal, and the delay period is equal to the transmission period plus a buffer period.

6. The ultra-low-latency game system according to claim 5, wherein when n is 1, the delay period is 1 ms, the scan cycle is 100 μs, the buffer period is 800 μs, and the transmission period is 200 μs.

7. The ultra-low-latency game system according to claim 6, wherein:
if a button state signal is acquired by one of the at least one game control device at a transmission start time point of the transmission period and is promptly stored in the buffer, it is then transmitted to the game console within the transmission period, resulting in a minimum delay time of 0.2 ms;
if a button state signal is acquired by one of the at least one game control device at a buffer start time point of the buffer period and is promptly stored in the buffer, it is then transmitted to the game console in the transmission period, resulting in a delay time of 1.0 ms;
if a button state signal was acquired by one of the at least one game control device during the transmission period of a previous delay period and was not promptly stored in the buffer, it is then transmitted to the game console during the transmission period of a current delay period, resulting in a maximum delay time of 1.2 ms;
wherein the transmission start time point is at 0 μs, at which the transmission period starts.

8. The ultra-low-latency game system according to claim 5, wherein each of the at least one game control device further comprises a button control positioning module and a switching module;
wherein the second UWB module is further configured to perform relative positioning of a corresponding one of the at least one game control device;
wherein the button control positioning module is configured to perform absolute positioning of a corresponding one of the at least one game control device;
wherein the switching module is configured to switch a positioning mode of a corresponding one of the at least one game control device between the second UWB module and the button control positioning module based on a game type of a game executed on the game console, thereby determining the positioning mode of the corresponding one of the at least one game control device as a UWB positioning mode or a traditional positioning mode;
wherein when the positioning mode of the corresponding one of the at least one game control device is the UWB positioning mode, the game console is configured to wirelessly communicate with the second UWB module of the corresponding one of the at least one game control device via the first UWB module, and the second UWB module is configured to determine a distance between the corresponding one of the at least one game control device and the game console, wherein the at least one game control device comprises multiple game control devices that wirelessly communicate with each other via the second UWB modules to determine mutual distances between the game control devices.

9. The ultra-low-latency game system according to claim 8, wherein when each of the game control devices determines that its positioning mode is the UWB positioning mode, it is configured to, at each delay period: transmit a positioning data signal to the second UWB modules of the other game control devices via its own second UWB module and record a transmission time; wait for feedback signals from the other game control devices and record a reception time; calculate real-time relative position information between itself and each of the other game control devices based on a time difference between the reception time and the transmission time as well as a data transmission rate; and each of the game control devices scans and acquires its corresponding button state signal and real-time relative position information, and promptly transmits them to the game console;
when each of the game control devices determines that its positioning mode is the traditional positioning mode, it is configured to, at each delay period, obtain its own real-time absolute position information via the button control positioning module; and each of the game control devices scans and acquires its corresponding button state signal and real-time absolute position information, and promptly transmits them to the game console.

10. The ultra-low-latency game system according to claim 9, wherein each of the game control devices further comprises a device control module and a game button, and the device control module is connected to each of the second ultra-low-latency communication module, the signal acquisition module, the buffer, the button control positioning module, the switching module, and the game button;
wherein the game console is configured to receive the real-time relative position information of each of the game control devices and, based on the received real-time relative position information, match in real time a relevant spatial position for a game character corresponding to each of the game control devices; and the game console is configured to receive the button state signal of each of the game control devices and, based on the received button state signal, match in real time a relevant game action for the game character corresponding to each of the game control devices.
